(19) United States
(12) Patent Application Publication
(10) Pub. No.: US 2004/0131399 A1
(43) Pub. Date: Jul. 8, 2004

(54) Image forming apparatus

(75) Inventor: Hiroshi Sahara, Ibaraki-ken (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/690,650

(22) Filed: Oct. 23, 2003

(30) Foreign Application Priority Data
Oct. 24, 2002 (JP) 2002-309688(PAT.)

(51) Int. Cl. G03G 15/00; G03G 15/20

(52) U.S. Cl. 399/322; 399/400

(57) ABSTRACT

An image forming apparatus has image bearing means for bearing a toner image, transfer means for transferring the toner image on the image bearing means onto a sheet, fixing means for fixing to the sheet the toner image, and first and second sheet transport guides disposed along a transport path. A sheet transport speed in the fog means is set lower than a sheet transport speed in the transfer means. The first and second sheet transport guides are each disposed with a tilt with respect to a horizontal or vertical direction. A gap is provided to form a spacing sufficient to permit curves of the sheet to be formed between a downstream-side end portion of the first sheet transport guide and an upstream-side end portion of the second sheet transport guide.

### BACKGROUND OF THE INVENTION

1. Field of the Invention

The present invention relates generally to image forming apparatuses such as copying machines, printers and facsimile machines that form images by using, for example, an electrophotographic scheme and an electrostatic recording scheme. More specifically, the invention relates to an intermediate-transfer-type image forming apparatus.

2. Description of the Related Art

In recent years, in the field of electrophotographic multicolor or full-color image forming apparatuses, so-called “in-line image forming apparatuses” are brought into practical use. The in-line image forming apparatuses have a plurality of photosensitive drums aligned in one line in units of a color, in which individual color toner images formed onto the individual photosensitive drums are sequentially superposed on an intermediate transfer member to form a color image.

FIG. 6 depicts an example of a conventional in-line electrophotographic full-color image forming apparatus (full-color copying machine) having an intermediate transfer member of the type described above. The image forming apparatus is configured of a printer section Pr and a reader section Sc. In this apparatus, image information of an original document sheet is obtained in the reader section Sc, and the image information is imaged over a transfer medium, such as paper, in the printer section Pr.

Image forming processes of the image forming apparatus will be outlined hereinbelow. When the image information is acquired from the original document she t in the reader section Sc, as described above, light exposure corresponding to th image information is performed by an exposure apparatus 101. Then, electrostatic latent images are formed on photosensitive drums 103 disposed in an image forming section 102. The individual drums 103 are assigned for handling yellow, magenta, cyan, and black toner images. Toners are then supplied onto the latent images in the image forming section 102, and toner images are then formed. The toner images are primary-transferred onto an intermediate transfer belt 104, and are then secondary-transferred onto a transfer medium P in a secondary transfer section Te in a nip section defined between a secondary-transfer opponent roller 105 and a secondary transfer roller 106. Finally, the secondary-transferred toner images are fixed to the transfer medium P with pressure and heat in fixing means 107, and a permanent image is formed on the transfer medium P.

In the intermediate-transfer-type image forming apparatus as described above (refer to Japanese Patent Application Laid-Open No. 2001-066948, for example), since, in particular, the endless-belt-type intermediate transfer belt 104 is used as the intermediate transfer member, a degree of freedom takes place for disposing members such as a transfer-medium transport section 108, the secondary transfer section Te, and the fixing means 107. Reportedly, this enables shortening a transfer-medium transport path for the distance from the transfer-medium transport section 108 to the fixing means 107 via the secondary transfer section Te, therefore providing an advantage in miniaturization of the apparatus.

However, it has been pointed out that shortening the transfer-medium transport path creates the problem of causing mutual interference between a transfer process in the secondary transfer section Te and a fixing process in the fixing m ans 107.

In m re detail, in the event that toner images are transferred to the transfer medium in the secondary transfer section Te and are fixed to the transfer medium P in the fixing means 107, a high quality image cannot be obtained unless the transfer medium P is transported at the speed controlled to be as constant as possible. However, since members, such as the secondary transfer section Te and the fixing means 107, are disposed close to each other, the fixing process in the fixing means 107 is undesirably commenced before completion of the transfer process in the secondary transfer section Te. At this event, suppose a case occurs in which, for example, the transfer-medium transport speed in the secondary transfer section Te is lower than the transfer-medium transport speed in the fixing means 107. In this case, the transfer medium P nipped in the secondary transfer section Te during the transfer process is forcedly pulled by the fixing means 107, thereby likely leading to an image defect.

Generally, to prevent the problem, the apparatus is designed such that a speed difference is provided between the transfer-medium transport speed in the secondary transfer section Te and the transfer-medium transport speed in the fixing means 107 (specifically, the transfer-medium transport speed in the fixing means 107 is set relatively lower). This causes the transfer medium P to form curves between the secondary transfer section Te and the fixing means 107 so that the curves sever as buffers to prevent the processes of the secondary transfer section Te and the fixing means 107 from being interfered with each other.

The transfer-medium transport speeds in the secondary transfer section Te and the fixing means 107 are influenced by factors, such as the type of the transfer medium, the density of the formed image, the operation environment, and the component durability. As such, it is very difficult to accurately control the speeds. For this reason, the speed difference between the transfer-medium transport speeds in the secondary transfer section Te and the fixing means 107 should be set with sufficient margins by taking all applicable conditions into account.

Under these circumstances, as shown in FIG. 7, depending on the condition, the curve between the secondary transfer section Te and the fixing means 107 can be grown larger. In this state, the image on the transfer medium P between the secondary transfer section Te and the fixing means 107 is unfixed. As such, when the curve is grown larger to an extent of bringing the transfer medium into contact with an interior portion of the apparatus main body, an image defect may occur, possibly entailing contamination of the apparatus interior. In addition, to prevent such contact with an interior portion of the apparatus, a sufficiently large spacing should be provided, thereby making it disadvantageous for miniaturization of the apparatus.

Further, as the curve is grown larger, the degree of freedom of the transfer medium P between the secondary transfer section Te and the fixing means 107 is increased. As such, wobbling, waviness, and/or the like of the transfer medium P can influence the secondary transfer section Te, the fixing means 107, and the like, thereby leading to the problem of causing, for example, an image defect and/or wrinkle of the transfer medium P.

### SUMMARY OF THE INVENTION

To overcome the problems described above, an object of the present invention is to improve transfer-medium transport performance to obtain high quality images without requiring the apparatus to be enlarged.

In order to achi ve the object describ d above, according to one aspect f the invention, an image forming apparatus comprises image bearing means for bearing a toner image; transfer means for transferring the toner image on the image bearing mean onto a sheet; fixing means for fixing to the sheet the toner image transferred by the transfer means; and sheet transport guide means for transporting a sheet placed along a sheet transport path between the transfer means and the fixing means, wherein a sheet transport speed in the fixing means is set lower than a sheet transport speed in the transfer means, and the sheet transport guide means is capable of forming a plurality of curves on the sheet between the transfer means and the fixing means.

According to another aspect of the invention, an image forming apparatus comprises image bearing means for bearing a toner image; transfer means for transferring the toner image on the image bearing means onto a sheet; fixing means for fixing to the sheet the toner image transferred by the transfer means; and a first sheet transport guide and a second sheet transport guide disposed from an upstream side of a transport direction of the sheet along a transport path of the sheet between the transfer means and the fixing means, wherein a sheet transport speed in the fixing means is set lower than a sheet transport speed in the transfer means, the first sheet transport guide is disposed with a tilt with respect to a horizontal direction or a vertical direction; the second sheet transport guide is disposed with a tilt with respect to the horizontal direction or the vertical direction; and a gap is provided to form a spacing sufficient to permit curves of the sheet to be formed between a downstream-side end portion of the first sheet transport guide and an upstream-side end portion of the second sheet transport guide.

According to still another aspect of the invention, an image forming apparatus comprises transfer means for transferring a toner image onto a sheet; fixing means for fixing to the sheet the toner image transferred by the transfer means; and a first sheet transport guide and a second sheet transport guide disposed from an upstream side of a transport direction of the sheet along a transport path of the sheet between the transfer means and the fixing means, wherein a sheet transport speed in the fixing means is set lower than a sheet transport speed in the transfer means, both an output direction of the sheet to be output from the transfer means and a tilt direction in a sheet transport direction of the first sheet transport guide are set downwardly from a horizontal direction, both an entering direction of the sheet into the fixing means and a tilt direction in a sheet transport direction of the second sheet transport guide are set upwardly from the horizontal direction, and a rear-end portion of the first sheet transport guide is positioned in substantially the center between the transfer means and the fixing means and is positioned upwardly from a front-end portion of the second sheet transport guide, whereby a spacing sufficient to permit curves of the sheet to be armed is formed.

As described above, the invention provides the configuration in which, while the transfer medium is being forwarded from the transfer means to the fixing means along the first and second sheet transport guides, the sheet is bent to form small “S”-shaped curves. Thereby, the invention improves the transport performance for transfer media, consequently enabling high quality images to be secured without requiring the apparatus to be enlarged.

### BRIEF DESCRIPTION OF THE DRAWINGS

FIG. 1 is a schematic configuration view of a transfer-medium transport path from a secondary transfer section to fixing means of an image forming apparatus according to a first embodiment of the invention;

FIG. 2 is a schematic configuration view of the image forming apparatus according to the first embodiment;

FIGS. 3A to 3C are views showing transfer-medium transport operations of the image forming apparatus according to the first embodiment;

FIG. 4 is a perspective view of a transfer-medium transport path from a secondary transfer section to fixing means of an image forming apparatus according to a second embodiment of the invention;

FIG. 5 is a perspective view of a transfer-medium transport path from a secondary transfer section to fixing means of an image forming apparatus according to a third embodiment of the invention;

FIG. 6 is a view showing an example of a conventional electrophotographic full color image forming apparatus having an in-line intermediate transfer member; and

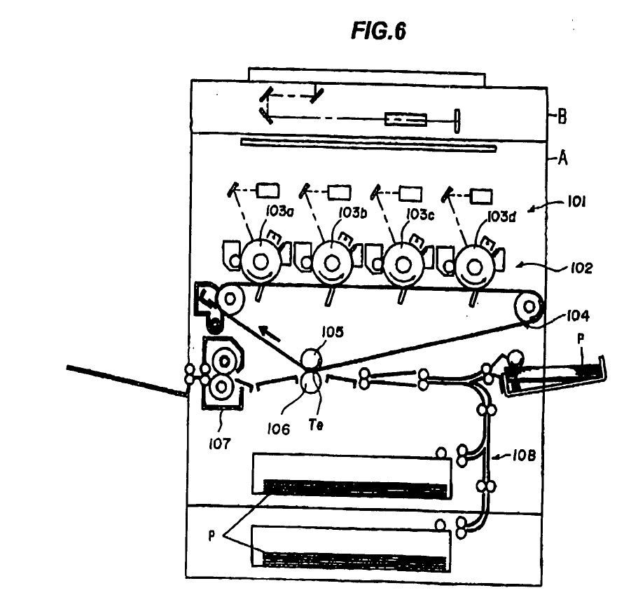

FIG. 7 is an explanatory view showing a case where a curve is enlarged between a secondary transfer section and fixing means of the conventional image forming apparatus.

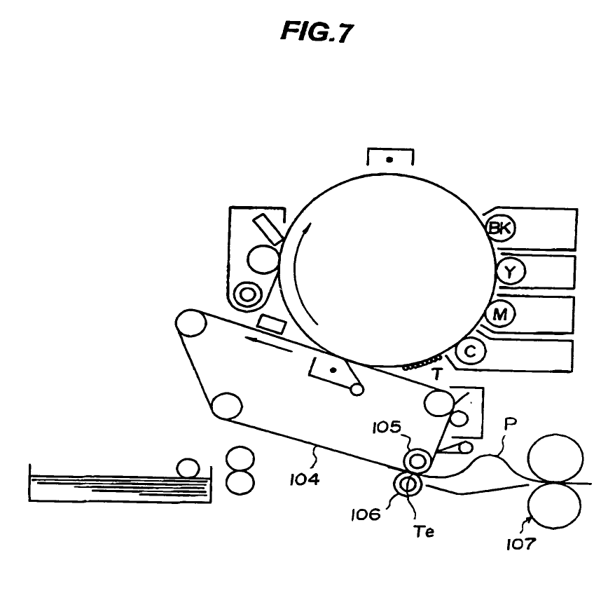

### DESCRIPTION OF THE PREFERRED EMBODIMENTS

The present invention will be described hereinbelow with reference to embodiments shown in the accompanying drawings.

### First Embodiment

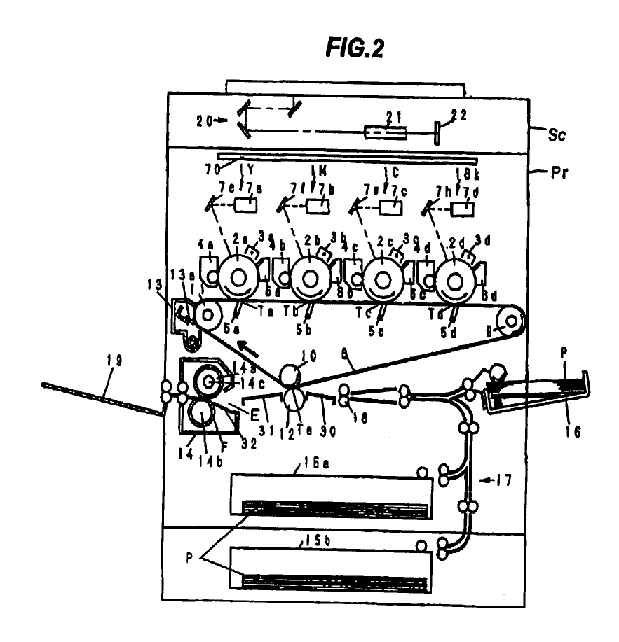

FIG. 2 is a schematic configuration view of an image forming apparatus (electrophotographic in-line full-color copying machine) according to a first embodiment of the invention.

(Image Forming Apparatus)

The image forming apparatus of the first embodiment has a configuration including a printer section Pr and a reader section Sc. The printer section Pr has four image forming sections (image forming units) 1Y, 1M, 1C, and 1Bk. The section 1Y forms yellow images, the section 1M forms magenta images, the section 1C forms cyan images, and section 1Bk forms black images. The four sections 1Y, 1M, 1C, and 1Bk are aligned along one line at predetermined intervals.

In the respective image forming sections 1Y, 1M, 1C, and 1Bk, there are mounted drum-type electrophotographic photosensitive units 2a, 2b, 2c, and 2d (each of which hereinbelow will be referred to as a photosensitive drum) that individually serve as image bearing members. Provided in peripheral portions of the respective photosensitive drums 2a, 2b, 2c, and 2d are chargers 3a, 3b, 3c, and 3d; developing units 4a, 4b, 4c, and 4d; transfer blades 5a, 5b, 5c, and 5d; and drum cleaning units 6a, 6b, 6c, and 6d. Exposure devices 7a, 7b, 7c, and 7d are mounted above portions between the respective chargers 3a, 3b, 3c, and 3d and the respective developing units 4a, 4b, 4c, and 4d. A yellow toner, a magenta toner, a cyan toner, and a black toner are stored in the developing units 4a, 4b, 4c, and 4d, respectively.

The individual photosensitive drums 2a, 2b, 2c, and 2d have photoconductive layers over aluminium drum bodies individually formed of negatively charged OPC photosensitive units, and are rotationally driving by a driver unit (not shown) at a predetermined process speed in the direction (counterclockwise) indicated by the arrow. Using a charging bias applied from a charging bias power source (not shown), the chargers 3a, 3b, 3c, and 3d serving as charger means uniformly charge the surfaces of the respective photosensitive drums 2a, 2b, 2c, and 2d to a predetermined negativ polarity potential.

The developing units 4a, 4b, 4c, and 4d cause toners of the individual colors to be adhered to individual electrostatic latent images formed on the corresponding photosensitive drums 2a, 2b, 2c, and 2d. Thereby, the individual electrostatic latent images are thereby developed (rendered visible) to form toner images. In this embodiment, a two-component contact developing scheme may be employed as a developing method to be performed by the developing units 4a, 4b, 4c, and 4d. According to this scheme, a developer formed by mixing magnetic carriers into toner particles is used. The developer is transferred by using a magnetic force, and toner images are developed onto the individual photosensitive drums 2a, 2b, 2c, and 2d in a contact state.

The transfer blades 5a, 5b, 5c, and 5d serving as transfer means are individually formed of resilient members. These blades 5a, 5b, 5c, and 5d are disposed in contact with the photosensitive drums 2a, 2b, 2c, and 2d, respectively, at nip portions of primary transfer sections Ta, Tb, Tc, and Td via an endless-belt-type intermediate transfer member 8 (which hereinbelow will be referred to as an “intermediate transfer belt”). Although the transfer blades 5 (5a, 5b, 5c, and 5d) are thus used as the transfer means, the transfer blades 5 may be replaced with transfer rollers. In this case, in the event of transferring toner images to the transfer medium, the transfer rollers may be applied with high pressure to thereby be in contact with the intermediate transfer belt 8.

The intermediate transfer belt 8 is placed with tension on a track with a driver roller 9, a secondary-transfer opponent roller 10, and a tension roller 11. The belt 8 is rotated (moved) through operation of the driver roller 9 in the direction indicated by the arrow (clockwise direction). The belt 8 is formed of a dielectric resin, such as a polycarbonate film, polyethylene terephthalate resin film, or polyvinylidene fluoride resin film.

The secondary-transfer opposition roller 10 is disposed in contact with a secondary transfer roller 12 via the intermediate transfer belt 8, whereby a secondary transfer section Te is formed. The secondary transfer roller 12 is disposed disengageable or engageable with respect to the intermediate transfer belt 8. A belt cleaning device 13 is disposed near the tension roller 11 situated on an outer side of the belt 8. The cleaning device 13 is responsible to remove and collect transfer residual toner remaining on the intermediate transfer belt 8. In the cleaning device 13, a plate-like blade member 13a formed of a resilient material is disposed in contact with the intermediate transfer belt 8. In addition, fixing means 14 having a fixing roller 14a and a pressure roller 14b is disposed downstream of the direction of transport of the transfer medium by the secondary transfer section Te.

The drum cleaning devices 6a, 6b, 6c, and 6d are provided that remove transfer residual toner remaining on the surfaces of the respective photosensitive drums 2a, 2b, 2c, and 2d by using blade members for toner collection. The exposure devices 7a, 7b, 7c, and 7d operate as described hereunder. A laser output section (not shown) outputs laser light modulated corresponding to image-information time-series electric digital pixel signals individually input from the reader section Sc. In response to the signals, the surfaces of the individual photosensitive drums 2a, 2b, 2c, and 2d are exposed to the laser light via individual polygon mirrors (not shown) or else. Thereby, electrostatic latent images of the individual colors corresponding to the image information are formed over the surfaces of the individual drums 2a, 2b, 2c, and 2d that have been charged by the chargers 3a, 3b, 3c, and 3d.

The reader section Sc has a scanner section 20 that emits light to an original document sheet (not shown) for performing scanning. Scan light (light deflected off the original document sheet) from the scanner section 20 is input to a charge-coupled device 22 (CCD) via an optical lens system 21 and is converted thereby into an electric signal. Subsequently, the electric signal undergoes processing such as color separation, and the results are then input to the individual exposure devices 7a, 7b, 7c, and 7d of the printer section Pr.

(Image Forming Operation)

Image forming operations of the image forming apparatus will be described hereinbelow. Upon input of an image-formation commencement signal, the individual photosensitive drums 2a, 2b, 2c, and 2d of the image forming sections 1Y, 1M, 1C, and 1Bk that are rotationally driven at a predetermined process speed are uniformly charged to a negative polarity through the respective chargers 3a, 3b, 3c, and 3d. Then, processes are performed with the exposure devices 7a, 7b, 7c, and 7d as described hereunder. Color-separation image signals representing image information of an original document sheet (not shown), which have been input through the reader section Sc, are individually converted into optical signals. Then, the signals are used to perform scan and exposure of the surfaces of the photosensitive drums 2a, 2b, 2c, and 2d via respective reflecting mirrors 7e, 7f, 7g, and 7h. Thereby, electrostatic latent images are formed.

Subsequently, first, the developing unit 4a applied with a developing bias having the same polarity as the charge polarity (negative polarity) of the photosensitive drum 2a operates to cause the yellow toner to be adhered to the electrostatic latent image formed over the drum 2a. Then, a yellow toner image is formed by rendering the electrostatic latent image to be visible. In the primary transfer section Ta between the drum 2a and the transfer blade 5a, the yellow ton r image is primary-transferred onto the rotating (moving) intermediate transfer belt 8 by using the blade 5a to which a primary-transfer bias (having the positive polarity opposite to the polarity of the toner) is applied. The intermediate transfer belt 8 having the yellow toner image transferred thereto is rotated (moved) toward the image forming section 1M. Then, processes similar to the above are performed in the image forming section 1M for a magenta toner image armed on the photosensitive drum 2b. That is, the magenta toner image is superimposed over the yellow toner image previously transferred to the intermediate transfer belt 8, and the superimposed toner images are then transferred in the primary transfer section Tb.

Subsequently, in similar manners, cyan and black toner images formed on the photosensitive drums 2c and 2d of the image forming sections 1C and 1Bk are sequentially superimposed, respectively, in the primary transfer sections Tc and Td on the yellow and magenta toner images that have been superimposed and transferred over the intermediate transfer belt 8. Thereby, a full color toner image is formed over the intermediate transfer belt 8.

An edge of the fill color toner image thus formed over the intermediate transfer belt 8 is transported to the secondary transfer section Te between the secondary-transfer opposition roller 10 and the secondary transfer roller 12. In line with the transport timing, a transfer medium P (paper) is selected from one of feeder cassettes 15a and 15b and a manual insertion cassette 16, and is fed via a transfer medium transport section 17. The transfer medium P is then transported by resist rollers 18 to the secondary transfer section Te. At this event, the secondary transfer roller 12 is brought into contact with the secondary-transfer opposition roller 10 via the intermediate transfer belt 8. Then, th individual color toner images are secondary-transferred in one time as a full color toner image to the transfer medium P by using the secondary transfer roller 12 to which a secondary-transfer bias (having the positive polarity opposite to the polarity of the toner) is applied.

The transfer medium P onto which the full color toner image has been formed is transported to the fixing means 14. Then, the full color toner image is heated and pressed by using a fixing nip disposed between the fixing roller 14a and the pressure roller 14b, and is thereby thermally fixed to form a full color image over the surface of the transfer medium P. Thereafter, the transfer medium P is output to an output tray 19. This completes a series of image forming processes.

In the configuration, a monochrome image can be obtained in the following manner. A specific image forming section (the image forming section 1Bk, for example) is used to primary-transfer a visible image to the intermediate transfer belt 8. Subsequently, processes similar to those for forming the full color image are performed, thereby enabling the monochrome image to be obtained.

In the primary transfer processes, primary-transfer residual toner remaining on the individual photosensitive drums 2a, 2b, 2c, and 2d is removed and collected by the respective drum cleaning devices 6a, 6b, 6c, and 6d. Secondary-transfer residual toner remaining on the intermediate transfer belt 8 after the secondary transfer processes is scraped off and collected by the blade member 13a of the belt cleaning device 13.

Additionally provided in the configuration are a pre-secondary-transfer guide 30, a first transfer medium transport guide 31, and a second transfer medium transport guide 32. The transfer guide 30 is disposed upstream of the direction of transport of the transfer medium P by the secondary transfer section Te to guide the transfer medium P to the secondary transfer section Te. The transport guides 31 and 32 are disposed downstream of the direction of transport of the transfer medium P by the secondary transfer section Te to guide the transfer medium P, onto which a toner image is transferred, to the fixing means 14.

The secondary transfer roller 12 is urged by a roller pressing spring (not shown) at an appropriate pressure (preferably at 5,880 to 39,200 mN) into contact with the secondary-transfer opposition roller 10 via the intermediate transfer belt 8. Thereby, the secondary transfer roller 12 is passively rotated with a frictional force caused between itself and the intermediate transfer belt 8. While the secondary transfer roller 12 is a resilient-material roller, such as an urethane rubber roller, having a diameter of 16 to 30 mm, the roller 12 may be a metal roller formed from an aluminum pipe, for example. Taking transport performance for the transfer medium P at the secondary transfer section Te into account, the configuration may be arranged such that the secondary transfer roller 12 is rotationally driven by a pulse motor or the like drive.

The first transfer medium transport guide 31 is provided downstream of the direction of transport of the transfer medium P by the secondary transfer section Te to guide the transfer medium P to the second transfer medium transport guide 32. The second transfer medium transport guide 32 is provided upstream of the direction of transport of the transfer medium P by the fixing means 14 to guide to a nip portion F of the fixing means 14.

The fixing means 14 is configured of the fixing roller 14a, which includes a heat source such as a halogen heater 14c, and the pressure roller 14b that is pressed by the fixing roller 14a (there can be a case that also the pressure roll r 14b has a heat source).

(Feature Portions f th First Embodiment)

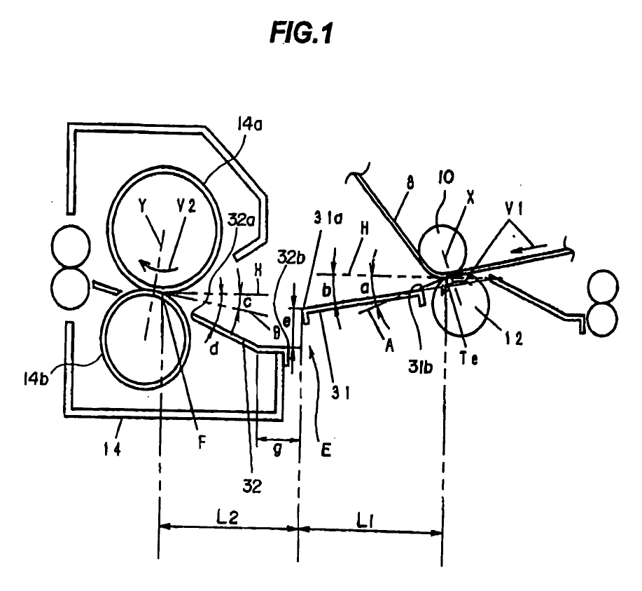

With reference to FIG. 1, feature portions of the first embodiment will be described hereinbelow. FIG. 1 is a schematic configuration view of a transfer-medium transport path from the secondary transfer section Te to the fixing means 14.

A transfer medium P is output from the secondary transfer section Te in a direction of a nip-portion tangent line A (perpendicular line extending from the transfer nip portion with respect to a center line X connecting the center of the secondary transfer roller 12 and the center of the secondary-transfer opposition roller 10). The tangent line A is set downward by an angle a with respect to a horizontal line H in the transfer-medium transport direction. A guide surface of the first transfer medium transport guide 31 is set downward by an angle b to the transport direction with respect to the horizontal line H in the transfer-medium transport direction. The relationship between the angles a and b is set to satisfy a>b.

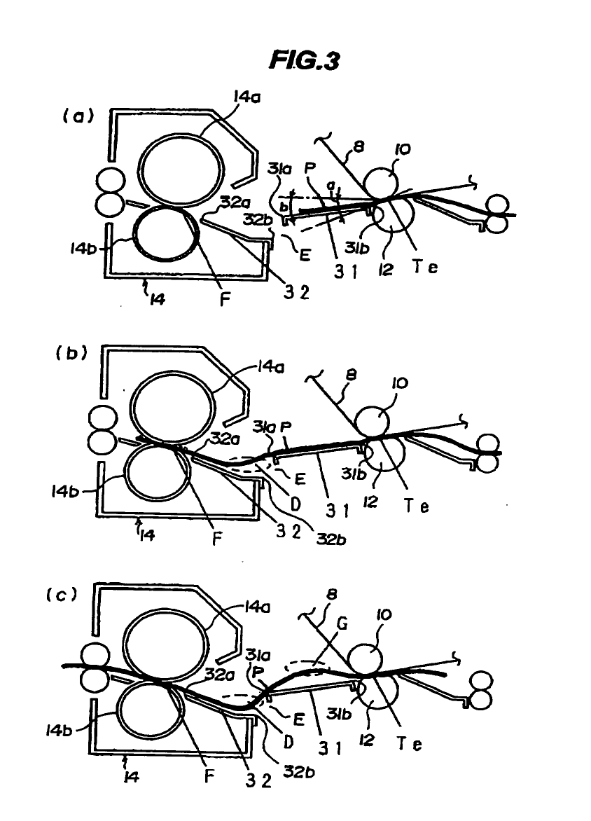

A front-end portion 31b (upstream-side end portion in the sheet transfer direction) of the first transfer medium transport guide 31 is disposed close to the nip between the secondary-transfer opposition roller 10 and the secondary transfer roller 12. A rear-end portion 31a (downstream-side end portion in the sheet transfer direction) of the transport guide 31 is disposed in substantially the center of the transfer-medium transport path from the secondary transfer section Te to the fixing nip portion F (L₁≈L₂ in FIG. 1). A gap E having a distance e is provided between the rear-end portion 31a of the first transfer medium transport guide 31 and a front-end portion 32b (downstream side in the sheet transfer direction) of the second transfer medium transport guide 32. The distance e of the gap E is appropriately set in accordance with the length of the transfer medium P to be transferred, the transfer-medium transport spe d in the transfer section Te, and the transfer-medium transport speed in the fixing means 14. However, the distance e is preferably set to about 5 mm to 20 mm. With the gap E being thus provided, a spacing D (shown in FIGS. 3C and 3D) is formed to permit curves of the sheet (transfer medium P), as will be described below. The guide surface of the second transfer medium transport guide 32 is formed to be substantially horizontal in a portion of a distance g from the rear-end portion 31a of the transport guide 31 and to be upwardly tilted at an angle d in the transport direction from the horizontal portion. In addition, a rear-end portion 32a (downstream-side end portion in the transport direction) of the second transfer medium transport guide 32 is provided close to a nip portion between the fixing roller 14a and the pressure roller 14b to guide the transfer medium P to the fixing nip portion F. The transfer medium P transported from the transport guide 32 enters from the direction of nip-portion tangent line B (perpendicular line extending from the fixing nip portion F with respect to a center line Y connecting the center of the fixing roller 14a and the center of the pressure roller 14b). The nip-portion tangential line B extends upwardly along the transport direction by an angle c from the horizontal line H in the transfer-medium transport direction.

In the secondary transfer section Te, the secondary transfer roller 12 and the intermediate transfer belt 8 are rotated at a speed V1 to transport the transfer medium P at the speed V1. The fixing roller 14a and the pressure roller 14b in the fixing means 14 are rotated at a rotation speed V2 to transport the transfer medium P at the speed V2. The speeds V1 and V2 are set in all times to satisfy V1>V2.

Transfer-m dium transport operations for the transfer medium P in the above-described configuration will be described hereinbelow with reference to FIGS. 3A to 3C. Referring first to FIG. 3A, the transfer medium P output from the secondary transfer section Te is transported to the fixing means 14 along the first transfer medium transport guide 81. In this event, since the angle b is smaller than the angle “a” of the output direction (nip-portion tangent line A) of the transfer medium P from the secondary transfer section Te, the transfer medium P is pressed by the first transfer medium transport guide 31. Consequently, the transfer medium P is always transported along the first transfer medium transport guide 31 without exception.

Referring then to FIG. 3B, the transfer medium P is guided to the fixing nip portion F. In this event, since the rotation speed V2 of the fixing roller 14a is lower than the speed V1, at which the transfer medium P has been transported by the secondary transfer roller 12 and the like rollers, the transfer medium P is bent to form a downwardly protruding curve (downward curve) in the initial spacing D. With reference to FIG. 3C, as the downward curve is grown larger in the spacing D, the transfer medium P is bent from a start portion in the rear-end portion 31a of the first transfer medium transport guide 31 to form an upwardly protruding curve (upward curve) in a spacing G above the first transfer medium transport guide 31. As such, when the transfer medium P is held by both the secondary transfer section Te and the fixing nip portion F, while the downward curve in the spacing D and the upward curve in the spacing G are being synchronously formed (the curves hereinbelow will be referred to as “S”-shaped curves), the transfer medium P is concurrently transported.

As described above, according to the first embodiment, the image forming apparatus is configur d such that factors such as the transport speed of th secondary transfer roller 12 and the transport speed of the fixing means 14 are preset. In addition, factors such as the angles of the first transfer medium transport guide 31 and the second transfer medium transport guide 32 are preset to permit the transfer medium P to form small “S”-shaped curves. With this configuration, since the individual curves formed on the transfer medium P can be small, large curve spacings need not be formed in the main body of the apparatus. This significantly contributes to miniaturization of the apparatus. In addition, since the individual curves are small, a transfer medium P bearing an unfixed image can be prevented from being brought into contact with an interior portion of the apparatus main body. As such, the apparatus main body interior is not contaminated by the contact, thereby enabling a defective image from being created because of the contact of the unfixed image surface. Further, since the individual curves are small, the degree of freedom of the transfer medium P is low. This consequently enables an abnormal image to be prevented from being created because of wobbling, waviness, and/or the like of the transfer medium P.

### Second Embodiment

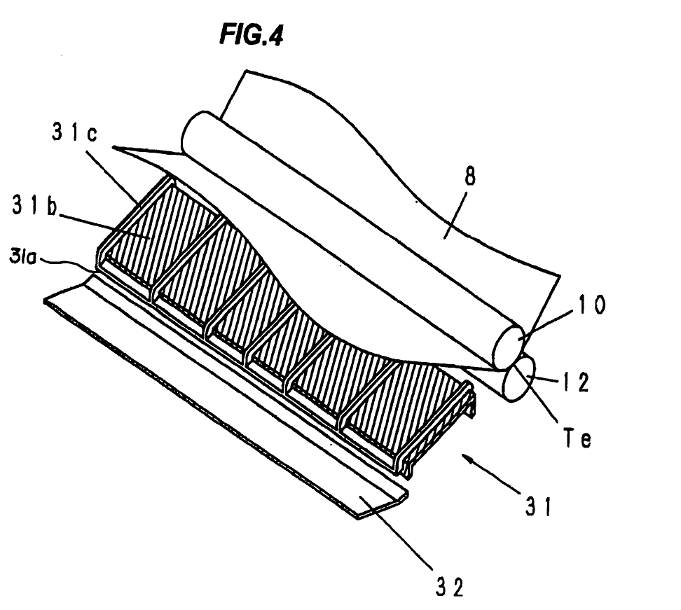

With reference to FIG. 4, feature portions according to a second embodiment of the invention will be described hereinbelow. FIG. 4 is a perspective view of a secondary transfer section Te, a first transfer medium transport guide 31, and a second transfer medium transport guide 32 according the second embodiment. The second embodiment has a configuration similar to the first embodiment in that “S”-shaped curves are armed from the start portion in a rear-end portion 31a of the first transfer medium transport guide 31. However, the second embodiment is capable of further stabilizing the behavior of the transfer medium P in a path along which the front end of the transfer medium P is transported to the fixing means.

In more detail the first transfer medium transport guide 31 is configured of guide ribs 31c, which are formed of a resin material to have a ladder-like shape, and a grounded metal guide plate 31b (hatched portion), in which a grounded metal surface is exposed in regions of the transport surface other than the guide ribs 31c. According to the configuration, the transfer medium P having passed through the secondary transfer section Te is electrically attracted to the guide plate 31b. As such, even in an event that the front end of the transfer medium P having passed through the secondary transfer section Te is curled, the transfer medium P is electrically adsorbed to the guide plate 31b. Therefore, the transfer medium P can stably be transported along the guide ribs 31c, and subsequent formation of “S”-shaped curves can smoothly be implemented.

### Third Embodiment

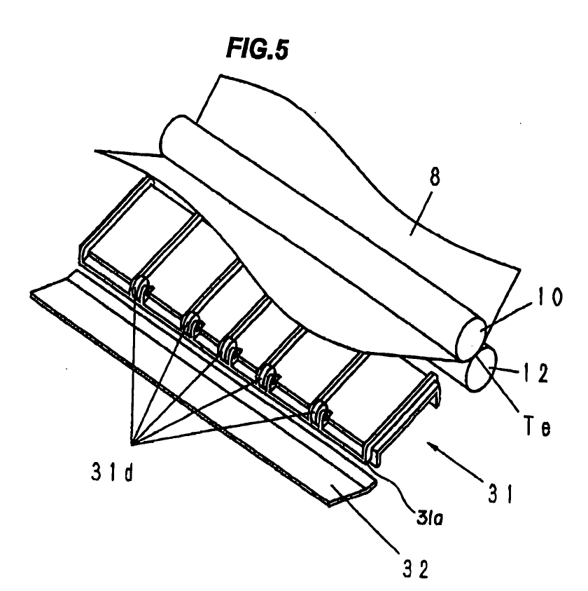

With reference to FIG. 5, feature portions according to a third embodiment of the invention will be described hereinbelow. FIG. 5 is a perspective view of a secondary transfer section Te, a first transfer medium transport guide 31, and a second transfer medium transport guide 32 according to the third embodiment. The third embodiment has a configuration similar to the first embodiment in that “S”-shaped curves are formed from the start portion in a rear-end portion 31a of the first transfer medium transport guide 31. However, among other things, the second embodiment has features for solving problems occurable in forming the curves.

In more detail, when, as shown in FIG. 3C, the “S”-shaped curves have been formed from the start portion in the rear-end portion 31a of the first transfer medium transport guide 31, since the transfer medium P having the curves is supported only by the rear-end portion 31a of the first transfer medium transport guide 31, local forces are exerted thereon. As such, sliding friction between the end portion 31a of the first transfer medium transport guide 31 causes loads to be imposed during transport, thereby unstabilizing the transport performance. In addition, triboelectrical charging is occurred by the sliding friction between the rear-end portion 31a of the first transfer medium transport guide 31 and the transfer medium P. The triboelectrical charging can cause an unfixed image to fluctuate, possibly leading to an image defect.

To overcome these problems, as shown in FIG. 5, the configuration is provided with a plurality of driven rollers 31d that are each formed of a resin material and are disposed in the width direction of the transfer medium P in a rear-end portion of the first transfer medium transport guide 31. According to this configuration, even in the event of forming “S”-shaped curves on the transfer medium P, the transfer medium P is transported in contact with the driven rollers 31d, therefore preventing sliding friction from occurring between the rear-end portion 31a of the first transfer medium transport guide 31 and the transfer medium P. Thereby, the transfer medium P can be smoothly bent to form curves, consequently enabling an image defect from being caused by triboelectrical charging.

### Other Embodiments

As above, the embodiments have each been discussed with reference to exemplifying the copying machine by way of the image forming apparatus of the invention. However, the image forming apparatus is not limited to a copying machine, and it may be any one of other apparatuses such as printers and facsimile machines.

Further, although the invention is well suited for image forming apparatuses using an intermediate transfer member with a spacing being preserved between transfer means and fixing means, such the intermediate transfer member is not necessarily required. For example, the invention may be adapted to image forming apparatuses of the type having a configuration in which a plurality of image bearing members individually bearing toner images are disposed opposite to a plurality of transfer means that transfer the toner images on the respective image bearing members onto a transfer medium via a transfer medium transport belt. In this configuration, images are formed while the transfer medium is being transferred between the image bearing members and the transfer means.

In the above case, factors such as the angle between the fixing means and closest one of the transfer means and the relationship between a first transfer medium transport guide 31 and a second transfer medium transport guide 32 may be set as those in the embodiments described above. Thereby, the configuration enables obtaining effects similar to those of the embodiments described above.

Further, each of the embodiments described above has disclosed the example cases in which the present invention is applied to the image forming apparatuses that transport the sheet in substantially the horizontal direction to perform transfer and fixing operations. However, the invention may be applied to other image forming apparatuses of the type that performs transfer and fixing in the course of transporting the sheet from a lower portion to an upper portion. In this case, with reference to FIG. 1, the configuration may be arranged such that the direction is set to a vertical direction V in place of the horizontal direction H, whereby the transfer means is set in the low r side, and the fixing means is set in the upper side. Thus, whil only th direction needs to be changed from the horizontal direction to the vertical direction, the basic configuration need not be modified.

What is claimed is:

1. An image forming apparatus comprising:
image bearing means for bearing a toner image;
transfer means for transferring the toner image on the image bearing means onto a sheet;
fixing means for fixing to the sheet the toner image transferred by the transfer means; and
sheet transport guide means for transporting a sheet placed along a sheet transport path between the transfer means and the fixing means,
wherein a sheet transport speed in the fixing means is set lower than a sheet transport speed in the transfer means; and
the sheet transport guide means is capable of forming a plurality of curves on the sheet between the transfer means and the fixing means.

2. The image forming apparatus according to claim 1, wherein the sheet transport guide means forms the plurality of curves in such a manner that:
in a downstream side of the transfer means, an upward curve protruding upwardly from a tangential line to a nip portion of the transfer means is formed; and
in an upstream side of the fixing means, a downward curve downwardly protruding from the tangential line to the nip portion of the fixing means is formed.

3. The image forming apparatus according to claim 1, wherein the sheet transport guide means forms the upward curve and the downward curve to be alternate on the sheet.

4. The image forming apparatus according to claim 1, wherein the transfer means comprises:
an interm diate transfer member onto which the toner image on the image bearing means is primary-transferred; and
secondary transfer means for secondary-transferring the toner image on the intermediate transfer member onto the sheet, the secondary transfer means being a transfer roller that is applied with a high pressure and is in contact with the intermediate transfer member when transferring the toner image to the sheet.

5. An image forming apparatus comprising:
image bearing means for bearing a toner image;
transfer means for transferring the toner image on the image bearing means onto the sheet;
fixing means for fixing to the sheet the toner image transferred by the transfer means; and
a first sheet transport guide and a second sheet transport guide disposed from an upstream side of a transport direction of the sheet along a transport path of the sheet between the transfer means and the fixing means,
wherein a sheet transport speed in the ring means is set lower than a sheet transport speed in the transfer means,
the first sheet transport guide is disposed with a tilt with respect to a horizontal direction or a vertical direction,
the second sheet transport guide is disposed with a tilt with respect to the horizontal direction or the vertical direction; and
a gap is provided to form a spacing sufficient to permit curves of the sheet to be formed between a downstream-side end portion of the first sheet transport guide and an upstream-side end portion of the second sheet transport guide.

6. The image forming apparatus according to claim 5, wherein the downstream-side nd portion of th first sheet transport guide is positioned in substantially the center between the transfer means and the fixing means.

7. The image forming apparatus according to claim 5, wherein a guide surface of the second sheet transport guide comprises: a flat face extending in the horizontal direction or the vertical direction in the upstream-side end portion; and a sloped face continuing from the flat face.

8. The image forming apparatus according to claim 5, wherein a tilt angle in the sheet transport direction of the first sheet transport guide is set smaller than an angle of outputting the sheet that is output from the transfer means.

9. The image forming apparatus according to claim 5, the gap between the first sheet transport guide and the second sheet transport guide is ranged from 5 mm to 20 mm.

10. The image forming apparatus according to claim 5, wherein the transfer means comprises:
an intermediate transfer member onto which the toner image on the image bearing means is primary-transferred; and
secondary transfer means for secondary-transferring the toner image on the intermediate transfer member onto the sheet, the secondary transfer means being a transfer roller that is applied with a high pressure and is in contact with the intermediate transfer member when transferring the toner image to the sheet.

11. An image forming apparatus comprising:
transfer means for transferring a toner image onto a sheet;
fixing means for fixing to the sheet the toner image transferred by the transfer means; and
a first sheet transp rt guide and a second sheet transport guide disposed from an upstream side of a transport direction of the sheet along a transport path of the sheet between the transfer means and the fixing means,
wherein a sheet transport speed in the fixing means is set lower than a sheet transport speed in the transfer means,
both an output direction of the sheet to be output from the transfer means and a tilt direction in a sheet transport direction of the first sheet transport guide are set downwardly from a horizontal direction,
both an entering direction of the sheet into the fixing means and a tilt direction in a sheet transport direction of the second sheet transport guide are set upwardly from the horizontal direction, and
a rear-end portion of the first sheet transport guide is positioned in substantially the center between the transfer means and the fixing means and is positioned upwardly from a front-end portion of the second sheet transport guide, whereby a spacing sufficient to permit curves of the sheet to be formed is formed.

12. The image forming apparatus according to claim 11, wherein a tilt angle in the sheet transport direction of the first sheet transport guide is set smaller than an angle of outputting the sheet that is output from the transfer means.

13. The image forming apparatus according to claim 11, wherein the transfer means comprises:
an intermediate transfer member onto which the toner image on the image bearing means is primary-transferred; and
secondary transfer means for secondary-transferring the toner image on the intermediate transfer member onto th sheet, the secondary transfer means being a transfer roller that is applied with a high pressure and is in contact with the intermediate transfer member when transferring the toner image to the sheet.

14. The image forming apparatus according to any one of claims 5 to 13, wherein the first sheet transport guide comprises a plurality of ribs on a sheet transport surface, and grounded metal surfaces are exposed in regions of the transport surface other than the ribs of the first sheet transport guide.

15. The image forming apparatus according to any one of claims 5 to 13, wherein a plurality of rotational members are disposed in a downstream-side end portion of the first sheet transport guide in the sheet transport direction, the plurality of rotational members being passively rotated through transport operation of the sheet without disturbing the transport operations of the sheet.
